(19) United States
(12) Patent Application Publication
(10) Pub. No.: US 2004/0185710 A1
(43) Pub. Date: Sep. 23, 2004

(54) Multi-stack desktop computer/set-top box audio connector

(76) Inventors: Gregory D. Thomas, Portland, OR (US); Robert D. Stoddard, Hillsboro, OR (US); Joe G. Bursey, Hillsboro, OR (US)

Correspondence Address: SCHWABE, WILLIAMSON & WYATT, P.C., PACWEST CENTER, SUITES 1600-1900, 1211 SW FIFTH AVENUE, PORTLAND, OR, 97204, US

(21) Appl. No.: 10/393,503

(22) Filed: Mar. 19, 2003

(51) Int. Cl. H01R 13/60

(52) U.S. Cl. 439/541.5

(57) ABSTRACT

A first and second plurality of audio input/output connectors are arranged and encased in a multi-stack manner to form a compact space saving audio connector, suitable for use e.g. on a motherboard designed for a compact desktop form factor personal computer, to facilitate provision of multi-channel audio. In one embodiment, each the first and second plurality of audio input/output connectors consist of 3 audio input/output connectors, whereas in another embodiment, the first plurality of audio input/output connectors consist of 3 audio input/output connectors, while the second plurality of audio input/output connectors consist of 2 audio input/output connectors.

### BACKGROUND OF THE INVENTION

1. Field of the Invention

The present invention relates to the field of connectors. More specifically, the present invention relates to desktop computer/set-top box audio connectors.

2. Background Information

Advances in integrated circuit and microprocessor technologies have led to wide spread deployment and adoption of computing devices. Examples of computing devices include servers, personal computers and “special” purpose computing devices. Personal computers may have form factors, such as desktop, laptop, tablet, and so forth. “Special” purpose computing devices may include set-top boxes, personal digital assistants (PDA), wireless mobile phones and so forth.

Concurrently, advances in content related technologies, such as audio and video related technologies, have led to increase in volume as well as richness in the nature of content available and consumed on computing devices. In the area of audio, recent advances have made possible the offering of multi-channel audio on desktop computers, set-top boxes and other devices of the like.

FIG. 6 illustrates an example prior art solution to facilitating the offering of multi-channel audio on a desktop computer, set-top box or a device of the like. More specifically, the solution is illustrated from the perspective of a “rear view”, looking from the back of an exposed chassis of a desktop computer or set-top box.

As illustrated, the example prior art solution involves the employment of multiple discrete connectors 604-606. These discrete connectors may include e.g. what is commonly referred to as a triple stack connector 604 to facilitate audio line-in, audio line-out and microphone-in, and a number of single port connectors 606 to facilitate surround sound and center/low frequency effect (LFE) outputs.

The solution is inefficient in that to facilitate mounting as well as reduction in the risk electrical interference, typically a small spatial gap is provided between any two discrete connectors. Resultantly, the base circuit board, and therefore the form factor of the desktop computer or set-top box may not be as compact as possible, had a more space efficient solution is available.

Thus, a more efficient approach to facilitate provision of multi-channel audio in desktop computers, set-top boxes, and other devices of the like, is desired.

### BRIEF DESCRIPTION OF DRAWINGS

The present invention will be described by way of exemplary embodiments, but not limitations, illustrated in the accompanying drawings in which like references denote similar elements, and in which:

FIGS. 1a-1b illustrate a perspective view of the multi-stack audio connection of the present invention, in accordance with two embodiments;

FIGS. 2a-2b illustrate an exposed side view of the multi-stack audio connection of the present invention, in accordance with two embodiments;

FIGS. 3a-3b illustrate a top view of the multi-stack audio connection of the present invention, in accordance with two embodiments;

FIGS. 4a-4b illustrate a schematic view of the wiring of the 3-port stack and the 2-port stack, in accordance with two embodiments;

FIG. 5 illustrates a computing device incorporated with the teachings of the present invention, in accordance with one example application; and

FIG. 6 illustrates a “front” view of a prior art solution to facilitate the offering of multi-channel audio on a desktop computer or set-top box.

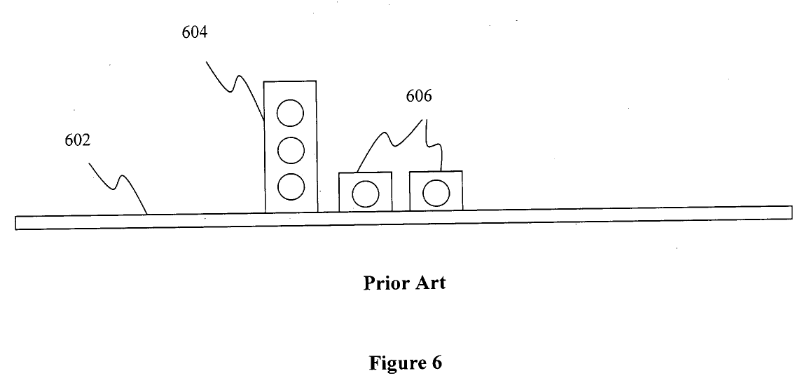

### DETAILED DESCRIPTION OF THE INVENTION

The present invention includes a multi-stack audio connector, having particular application to facilitate provision of multi-channel audio on a desktop computer, set-top box or other apparatuses of the like.

In the following description, various configurations will be described, to provide a thorough understanding of the present invention. However, the present invention may be practiced without some of the specific details or with alternate storage elements and/or combinatorial logics. In other instances, well-known features are omitted or simplified in order not to obscure the present invention.

The description to follow repeatedly uses the phrase “in one embodiment”, which ordinarily does not refer to the same embodiment, although it may. The terms “comprising”, “having”, “including” and the like, as used in the present application, including in the claims, are synonymous.

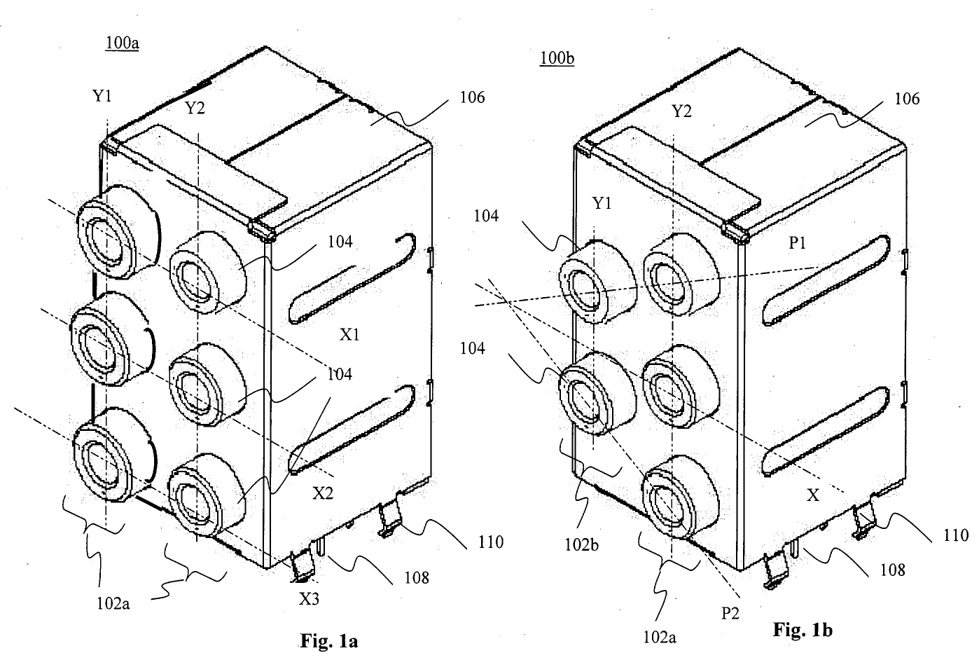

Referring now to FIGS. 1a-1b, wherein two perspective views of the multi-stack audio connector of the present invention, in accordance with two embodiments, are illustrated. As shown, each of the two embodiments includes at least two stacks 102a/102b of audio ports 104. In each case, the two stacks 102a/102b of audio ports 104 are advantageously encased by a single casing 106. Casing 106 includes mounting features 108/110 for facilitating mounting multi-stack audio connector 100a/100b to a circuit board, e.g. a motherboard of a desktop computer, a set-top box or other apparatuses of the like.

Resultantly, the plurality of audio ports 104 may be provided in an efficient space saving manner.

For the embodiment of FIG. 1a, each of the two stacks 102a includes 3 audio ports 104. Whereas for the embodiment of FIG. 1b, one stack 102a includes 3 audio ports 104, and the other stack 102b includes 2 audio ports.

In alternate embodiments, the present invention may be practiced with the integrated multi-stack connector having more than two multi-port stacks, and each port stack having more or less ports.

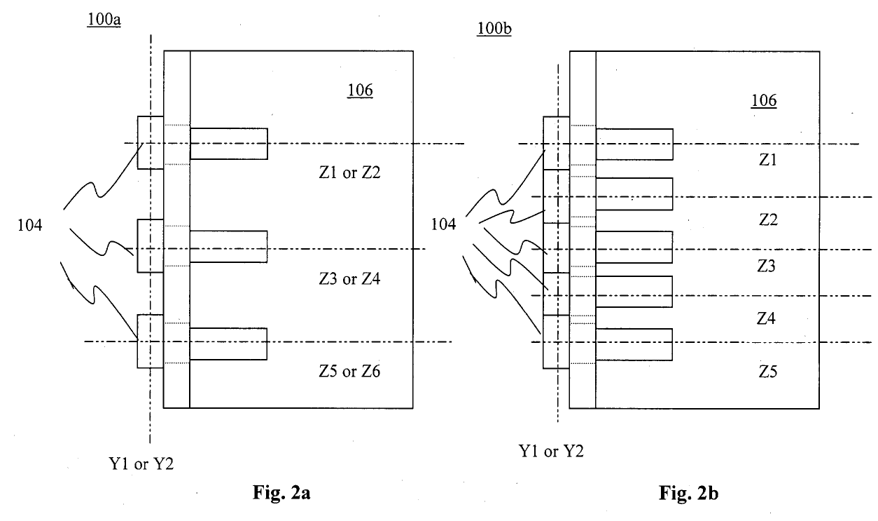

For the embodiment of FIG. 1a, audio ports 104 of the two stacks 102a may be considered as being disposed along, as well as orthogonal to two spatially separated vertical axes Y1 and Y2 (see also FIG. 2a, where an exposed side view of connector 100a is shown).

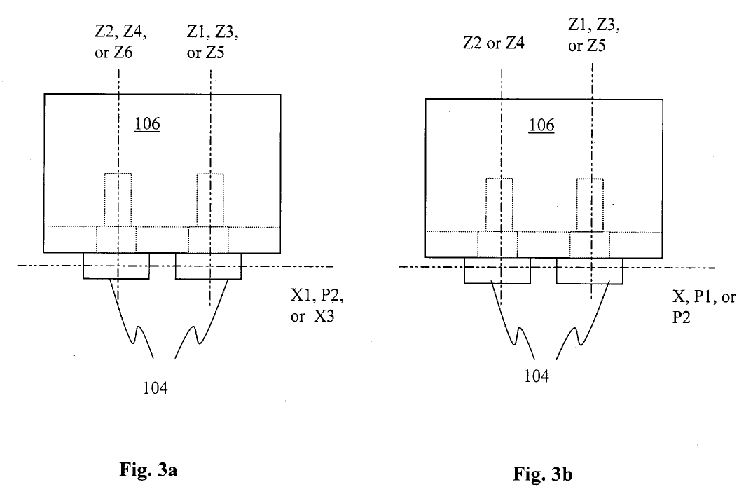

Alternatively, audio ports 104 of the two stacks 102a may also be considered as being disposed along, as well as orthogonal to three spatially separated horizontal axes X1, X2 and X3 (see also FIG. 3a, where a top view of connector 100a is shown).

For the embodiment of FIG. 1b, audio ports 104 of the two stacks 102a and 102b may be considered as being disposed along, as well as orthogonal to two spatially separated vertical axes Y1 and Y2 (see also FIG. 2b, where an exposed side view of connector 100b is shown).

Alternatively, audio ports 104 of the two stacks 102a/102b may be considered as having the middle port of stack 102a disposed at an intersection of the X and Y2 axes, and the top ports of stacks 102a-102b being disposed along, as well as orthogonal to two inclined/angled linear axes P1 and P2, relative to axes X and Y (see also FIG. 3b, where a top view of connector 100b is shown).

For the embodiment of FIG. 1a, in one implementation, the left 3 port stack 102a of connector 100a comprises an audio line-in port, an audio line-out port, and a microphone-in port, whereas the two lower ports of the right 3 port stack 102a comprises a surround sound port, and a center/LFE port. The top port of the right 3 port stack 102a comprises a digital audio output port, e.g. a Sony/Philip Digital Interface (S/PDIF) port.

In an alternate embodiment, the top port of the right 3 port stack 102a may be a digital audio input port instead.

For the embodiment of FIG. 1b, in one implementation, the right 3 port stack 102a of connector 100b comprises an audio line-in port, an audio line-out port, and a microphone-in port, whereas the left 2 port stack 102b of connector 100b comprises a surround sound output port and a center/LFE port.

In alternate embodiments, different audio functions or types of audio may be associated with one or more of the foregoing described audio ports.

Referring briefly back to FIGS. 1a-1b, for the illustrated embodiments, mounting features 108-110 may comprise mounting poles 108 and deflectable hooks 110.

In one embodiment, mounting poles 108 and deflectable hooks 100 may be designed for a mounting force in the range of 0.4 to 3.0 kgf.

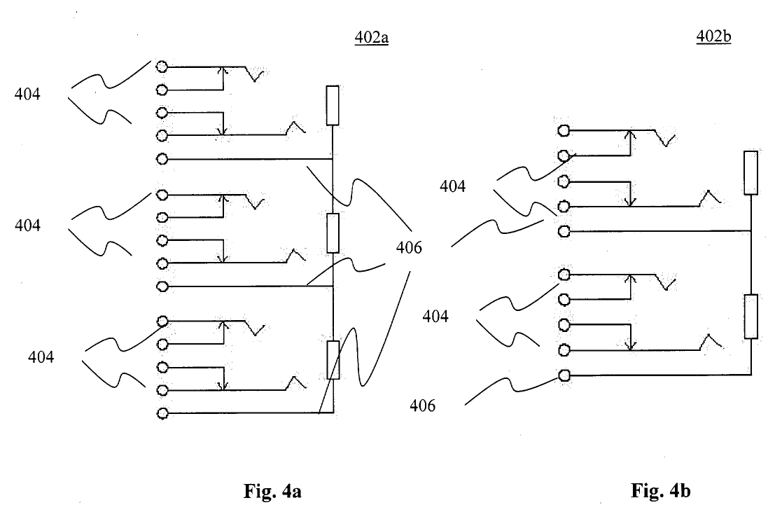

Referring now to FIGS. 4a-4b, wherein one embodiment each of the wiring for the 3 port and 2 port stack are illustrated. Wiring 402a for a 3 port stack 102a comprises 3 pairs of contacts 404 and 3 corresponding grounds 406, whereas wiring 402b for a 2 port stack 102b comprises 2 pairs of contacts 404, and 2 corresponding grounds 406.

In one embodiment, each pair of contacts may be designed for a current rating of 1 amp, and dielectric withstanding voltage of 500vac. Further, the insulation resistance may be greater than 100megohm, and the contact resistance may be smaller than 50 milliohm.

In various embodiments, the contacts and wiring may be constituted with any number of materials known in the art. In one embodiment, the contacts are constituted with copper alloy, whereas the traces are constituted with copper wires. In various embodiments, the contacts may also be constituted with nickel, gold, tin and/or lead plating.

In alternate embodiments, the contacts and wiring may be designed with other electrical and/or physical characteristics, employing different materials.

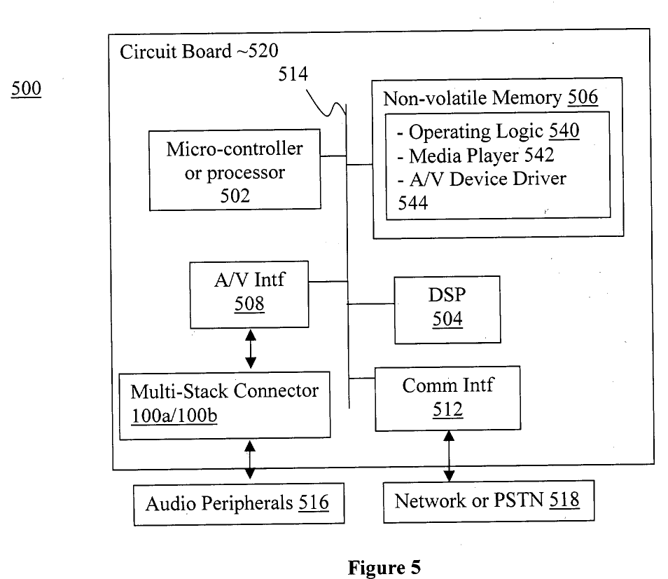

FIG. 5 illustrates a computing device incorporated with the teachings of the present invention, in accordance with one embodiment. As illustrated, computing device 500 includes in particular, A/V interface 508 and multi-stack connector of the present invention 100a/100b, coupled to each other as shown. One or more audio devices 516 are in turn coupled to multi-stack connector 100a/100b.

Additionally, computing device 500 includes processor 502, DSP 504, non-volatile memory 506, and communication interface 512, coupled to each other and audio/video (A/V) interface 508, via bus 514. Non-volatile memory 506 includes operating logic 540 having media player 542 and A/ device driver 544. The elements are disposed on circuit board 520.

Except for novel employment of multi-stack connector of the present invention 100a/100b, the enumerated elements otherwise perform their conventional functions. For examples, processor 502 and/or DSP 504 execute media player 542 and/or A/V device driver 544 to facilitate audio input/output, and A/V interface 508, among other functions, perform analog-to-digital and/or digital-to-analog signal conversion. The elements are known in the art. Accordingly, computing device 500 represents a broad range of computing devices known in the art, including but are not limited to desktop computers, set-top boxes, multi-media control center, and so forth.

Thus, it can be seen from the above descriptions, a more efficient multi-stack audio connector, suitable for use to facilitate provision of multi-channel audio on desktop computer, set-top boxes or other apparatuses of the like, have been described. While the present invention has been described in terms of the foregoing embodiments, those skilled in the art will recognize that the invention is not limited to these embodiments. The present invention may be practiced with modification and alteration within the spirit and scope of the appended claims. Accordingly, the description is to be regarded as illustrative instead of restrictive on the present invention.

What is claimed is:

1. A multi-stack audio connector comprising:
a first plurality of audio input/output connectors, each having an opening, vertically disposed along and orthogonal to a first vertical axis;
a second plurality of audio input/output connectors, each having an opening, vertically disposed along and orthogonal to a second vertical axis spatially separated from the first vertical axis; and
a casing encasing the first as well as the second plurality of audio input/output connectors, the casing including mounting features to facilitate mounting of the multi-stack audio connector on a circuit board.

2. The multi-stack audio connector of claim 1, wherein each of the first and second plurality of audio input/output connectors consist of 3 audio input/output connectors.

3. The multi-stack audio connector of claim 2, wherein the first 3 audio input/output connectors comprise an audio line-in connection, an audio line-out connector and a microphone-in connector, and the second 3 audio input/output connectors comprise a digital audio output connector, a surround sound output connector and a center/low frequency effect output connector.

4. The multi-stack audio connector of claim 1, wherein the second plurality of audio input/output connectors comprise at least one digital audio output connector and one analog output connector.

5. The multi-stack audio connector of claim 1, wherein the first and second plurality of audio input/output connectors comprise at least one digital audio output connector and one analog output connector.

6. The multi-stack audio connector of claim 1, wherein the first plurality of audio input/output connectors consist of 3 audio input/output connectors, and the second plurality of audio input/output connectors consist of 2 audio input/output connectors.

7. The multi-stack audio connector of claim 6, wherein
a first of second 2 audio input/output connectors occupying a first spatial position on the second vertical axis, that is lower than a first position on the first vertical axis occupied by a first of the first 3 audio input/output connectors, but higher than a second position on the first vertical axis occupied by a second of the first 3 audio input/output connectors; and
a second of second 2 audio input/output connectors occupying a second spatial position on the second vertical axis, that is lower than the second position on the first vertical axis occupied by a second of the first 3 audio input/output connectors, but higher than a third position on the first vertical axis occupied by a third of the first 3 audio input/output connectors.

8. The multi-stack audio connector of claim 6 wherein the first 3 audio input/output connectors comprise an audio line-in connection, an audio line-out connector and a microphone-in connector, and the second 2 audio input/output connectors comprise a surround sound output connector and a center/low frequency effect output connector.

9. A multi-stack audio connector comprising:
a first plurality of audio input/output connectors, each having an opening, horizontally disposed along and orthogonal to a first horizontal axis;
a second plurality of audio input/output connectors, each having an opening, horizontally disposed along and orthogonal to a second horizontal axis spatially separated from the first vertical axis; and
a casing encasing the first as well as the second plurality of audio input/output connectors.

10. The multi-stack audio connector of claim 9, wherein each of the first and second plurality of audio input/output connectors consist of 2 audio input/output connectors.

11. The multi-stack audio connector of claim 9, wherein the first 2 audio input/output connectors comprise a microphone-in connector and a center/low frequency effect output connector, and the second 2 audio input/output connectors comprise an audio line-out connector and a surround sound output connector.

12. The multi-stack audio connector of claim 9, wherein the first 2 audio input/output connectors comprise an audio line-in connector and a digital audio output connector, and the second 2 audio input/output connectors comprise an audio line-out connector and a surround sound output connector.

13. The multi-stack audio connector of claim 9, wherein the first 2 audio input/output connectors comprise a microphone-in connector and a center/low frequency effect output connector, and the second 2 audio input/output connectors comprise an audio line-in connector and a digital audio output connector.

14. The multi-stack audio connector of claim 9, wherein the casing further comprises mounting features to facilitate mounting of the multi-stack audio connector on a circuit board.

15. A multi-stack audio connector comprising:
a first audio input/output connector, having an opening, disposed at an intersection of a vertical and a horizontal axis, and orthogonal to both axes;
a first plurality of audio input/output connectors, each having an opening, disposed along and orthogonal to a first angled axis;
a second plurality of audio input/output connectors, each having an opening, disposed along and orthogonal to a second angled axis forming a substantially right angle with the first angled axis; and
a casing encasing the first as well as the second plurality of audio input/output connectors.

16. The multi-stack audio connector of claim 15, wherein each of the first and second plurality of audio input/output connectors consist of 2 audio input/output connectors.

17. The multi-stack audio connector of claim 16, wherein the first audio input/output connector is an audio line-out connector, the first 2 audio input/output connectors comprise a microphone-in connector and a center/low frequency effect output connector, and the second 2 audio input/output connectors comprise an audio line-out connector and a surround sound output connector.

18. The multi-stack audio connector of claim 15, wherein the casing further comprises mounting features to facilitate mounting of the multi-stack audio connector on a circuit board.

19. An apparatus comprising:
a multi-stack audio connector having
a first plurality of audio input/output connectors, each having an opening, vertically disposed along and orthogonal to a first vertical axis,
a second plurality of audio input/output connectors, each having an opening, vertically disposed along and orthogonal to a second vertical axis spatially separated from the first vertical axis, and
a casing encasing the first as well as the second plurality of audio input/output connectors;
a non-volatile memory including a media player to perform at least a selected one of processing audio inputted through the multi-stack audio connector and outputting audio through the multi-stack audio connector; and
a processor coupled to the non-volatile memory to execute the media player.

20. The apparatus of claim 19 wherein each of the first and second plurality of audio input/output connectors of the multi-stack audio connector consist of 3 audio input/output connectors.

21. The apparatus of claim 19, wherein the first plurality of audio input/output connectors of the multi-stack audio connector consist of 3 audio input/output connectors, and the second plurality of audio input/output connectors of the multi-stack audio connector consist of 2 audio input/output connectors.

22. The apparatus of claim 19, wherein the apparatus is a selected one of a desktop computer and a set-top box.
